(19) United States
(12) Patent Application Publication
(10) Pub. No.: US 2018/0007742 A1
(43) Pub. Date: Jan. 4, 2018

(54) METHOD AND DEVICE FOR APPLYING A HEATING SYSTEM AND EXTERNAL REAR-VIEW DEVICE WITH A HEATING SYSTEM

(71) Applicant: SMR Patents S.à.r.l., Luxembourg (LU)

(72) Inventor: Andreas Herrmann, Winnenden-Baach (DE)

(21) Appl. No.: 15/636,326

(22) Filed: Jun. 28, 2017

(30) Foreign Application Priority Data
Jun. 29, 2016 (DE) 20 2016 103 464.7

(51) Int. Cl. H05B 3/84; H05B 3/36; H05B 3/14; B60R 1/06; C01B 32/168

(52) U.S. Cl. CPC H05B 3/845; H05B 3/145; B60R 1/0602; H05B 3/36; C01B 32/168; C01B 2202/24; H05B 2203/013

(57) ABSTRACT

A method for applying a heating system on a surface includes providing an imprint form including a basic form and an arm, tampon printing a plurality of heating elements on the surface with the imprint form such that each heating element has the basic form of the imprint form and is produced with a guide arm by the arm of the respective imprint form, where two adjacent heating elements are connected by the guide arm, and the heating elements are made from a conductive substrate including conductive particles, and connecting the heating elements to at least one heating conductor or heating segment.

### CROSS-REFERENCE TO RELATED APPLICATIONS

This application claims the benefit of priority to German Patent Application No. 20 2016 103 464.7 filed Jun. 29, 2016, which is hereby incorporated by reference in its entirety for all purposes.

### STATEMENT REGARDING FEDERALLY SPONSORED RESEARCH OR DEVELOPMENT

Not applicable.

### REFERENCE TO A COMPACT DISK APPENDIX

Not applicable.

### BACKGROUND OF THE INVENTION

### 1. Field of the Invention

The following description relates to a method and device for applying a heating system. For example, for applying a heating system to an external rear-view device for vehicles. The following description also relates to an external rear-view device with such a heating system.

### 2. Description of Related Art

As described in German Patent Application No. DE 10 2011 056 174 A1, an external rear-view mirror for vehicles, particularly motor vehicles, is known, with the mirror having at least one mirror surface which at least in part rests on a mirror glass support. An edge region is thermally decoupled from the mirror glass support and can be heated by means of a heating device, preferably arranged at least in part between the mirror surface and the mirror glass support. Here, the heating device can include a flat heating element. Further, at least in part between the mirror surface and the mirror glass support, at least one connecting device for connecting the mirror surface with the mirror glass support is arranged, where the heating device is preferably integrated into the connecting device and/or forms at least part of the connecting device. The connecting device can include at least an adhesion element, such as an adhesive foil and/or an adhesive film.

German Patent Application No. DE 10 2011 107 134 A1 describes a mirror glass for a motor vehicle external rear-view mirror arrangement with integrated mirror glass heating. The mirror glass includes, seen from its front side onwards, a glass substrate, a mirror layer applied to the rear of the glass substrate, a scratch-resistant layer applied to the rear of the mirror layer and an imprinted heat conductor constituting the mirror glass heating system. Here, on the rear of the scratch-resistant layer, a first insulation layer is arranged. The heating conductor includes a conductive lacquer track and at least two contact surfaces configured at remote ends of at least one conductive lacquer track and having an electrically conducting connection with this for electrical contacting of at least one conductive lacquer track, imprinted on the rear of the first insulation layer in an electrically conducting conductive lacquer. On the rear of the first insulation layer imprinted with the heating conductor, a second insulation layer is arranged, which is provided with congruent sections with recesses forming part of the contact surfaces. In the congruent sections of the heating conductor, electrically contacting contact elements are arranged with a mechanically fastening and electrically conducting connection with the contact surfaces.

French Patent Application No. FR 2 618 396 A1 relates to a device for heating a rear-view mirror for a motor vehicle. The device is made up of a flexible support, which is made of polyester or mylar cut to the shape of the glass of the rear-view mirror and on which there is deposited, by silk screen printing, an electric circuit using a resistive ink. The two ends of the circuit are each provided with a terminal for connection to an electric supply circuit, and the face of the support is provided with the circuit being covered by a double-sided adhesive for welding it onto the back face of the glass of the rear-view mirror.

A method for producing a carbon nanotube heating apparatus is described in German Patent Application No. DE 10 2014 224 842 A1. The method includes preparing a solution of a polymer material, a solvent and a carbon additive, applying at least one layer of the solution to a substrate, attaching conductive elements to the layer, and coating of the conductive elements with protective elements, wherein the substrate material has properties similar to the polymer material of the solution. The inner heating layer consisting of metallic circuits is removed by printing a layer of nanotubes on the actual support of the mirror, thereby allowing the mirror to be heated with the same performance but without this component.

German Patent Application No. DE 20 2011 102 425 U1 describes an electric line with at least one conductive substrate and at least one substrate carrier, on and/or in which the conductive substrate is arranged, wherein the conductive substrate has conductive particles. Here the conductive particles can comprise carbon nanotubes (CNT), and the conductive substrate can be imprinted using tampon printing.

### SUMMARY OF THE INVENTION

In one aspect of the invention, an object is to provide an easy method for applying a heating system in particular to an external rear-view device for vehicles. In particular, it is intended to dispense with complicated attachment processes for heating elements when free-form surfaces are used. Moreover, it is intended that the applied heating system has a long service life and is visually appealing.

This objective may be achieved by means of a method of claim 1. Preferred methods of the invention are described in claims 2 to 7.

The invention also provides a device for applying a heating system to a surface, particularly a free-form surface, using tampon printing, with a method of the invention.

Here at least one imprint form, preferably on a robot arm, can be provided for.

Further, the invention also provides an external rear-view device for a vehicle with a heating system applied with the method according the invention.

According to another aspect of the invention, the use of imprint forms each having a link arm allows for applying heating elements such that they are controlled overlapping with adjacent heating elements. Imprinting in tampon printing, preferably by a free-acting robot arm, allows to provide free-form surfaces with a heating system in a simple manner. The design of the imprint forms, particularly their basic forms, and thus the design of the heating elements, can be selected not only to be adapted to specific free-form surfaces, but also to increase the visual appeal of the surface to which the heating elements have been applied according to the invention.

Further features and advantages of the invention are indicated by the following description, in which preferred embodiments of the invention are explained using the attached, schematic drawings.

### BRIEF DESCRIPTION OF THE SEVERAL VIEWS OF THE DRAWINGS

The foregoing summary, as well as the following detailed description, will be better understood when read in conjunction with the appended drawings. For the purpose of illustration, there is shown in the drawings certain embodiments of the present disclosure. It should be understood, however, that the invention is not limited to the precise arrangements and instrumentalities shown. The accompanying drawings, which are incorporated in and constitute a part of this specification, illustrate an implementation of systems and apparatuses consistent with the present invention and, together with the description, serve to explain advantages and principles consistent with the invention.

FIGS. 1A, 1B, 1C, 1D, 1E, 1F, and 1G are diagrams illustrating a plan view of an imprint form for applying a heating system with a method according to the invention.

FIGS. 2A and 2B each show a view of heating segments of a heating system applied according to the invention.

### DETAILED DESCRIPTION

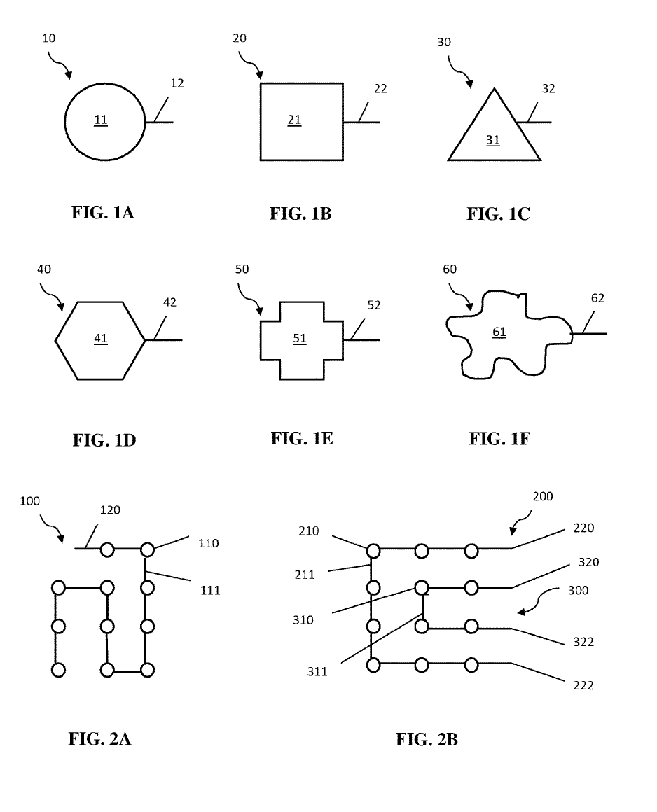

FIG. 1A shows a first imprint form 10, which for its part has a basic form 11 and a link arm 12. In this example, the basic form 11 is, by way of example, circular. Such an imprint form 10 is preferably used for tampon printing with a freely-acting robot arm, in order to provide a surface with any desired form with a heating element. To this end, on the imprint form 10, and indeed on the basic form 11 and the link arm 12, a conductive substrate is applied. The conductive substrate preferably comprises conductive particles in CNT. The imprint form 10 provided with the conductive substrate is then imprinted on the surface.

As an alternative to the imprint form 10 of FIG. 1A, imprint forms 20, 30, 40, 50 or 60 with differently formed basic forms 21, 31, 41, 51, 61, and each with a link arm 22, 32, 42, 52, and 62, respectively, according to FIGS. 1B-1F, can be used in tampon printing. The basic form can be selected as desired and is generally determined by design considerations.

By means of the imprint form 10, the conductive substrate can be applied to the surface acting as a substrate carrier, to print the surface directly, i.e. without the interposing of an adhesive layer or similar, with a heating system. Through suitable dimensioning of the imprint form 10, it is possible to print almost any free-form surface desired with conductive particles so as to design the surface of this to be heatable.

Through the imprinting, a heating conductor or heating segment 100 according to FIG. 2A can be produced, in that the imprint form 10 is imprinted multiple times on the substrate carrier or the surface, in particular via the robot arm, and in fact by step-by-step movement of the imprint form 10, so that a controlled overlap of a guide arm 111 generated by the link arm 12 with the following heating element 110 generated by the basic body 11 results. The heating segment 100 is shown with a free guide arm for providing a contact end 120.

Alternatively, in FIG. 2B, a heating system with two heating segments 200 and 300 is shown, with which through the basic form 11 and the link arm 12 of imprint form 10 heating elements 210, 310 with guide arms 211, 311 are imprinted on a substrate carrier (not shown). Here, free guide arms can provide contact ends 222 and 322 and, additionally, contact ends 220 and 320 can be produced by a separate imprint form (not shown). A power supply can be attached to the contact ends.

The route of the heating segments, i.e. the relative arrangement of the heating elements is freely selectable by controlling the robot arm with the imprint form. A heating segment can also be produced by means of at least two different imprint forms. This allows heating systems with different designs or patterns to be produced.

The features disclosed in the above description, in the claims and in the drawings, can be essential both individually and in any desired combinations to the invention in its various embodiments.

### LIST OF REFERENCE NUMERALS

10 Imprint form
11 Basic form
12 Link arm
20 Imprint form
21 Basic form
22 Link arm
30 Imprint form
31 Basic form
32 Link arm
40 Imprint form
41 Basic form
42 Link arm
50 Imprint form
51 Basic form
52 Link arm
60 Imprint form
61 Basic form
62 Link arm
100 Heating segment
110 Heating element
111 Guide arm
120 Contact end
200 Heating segment
210 Heating element
211 Guide arm
220 Contact end
222 Contact ends
300 Heating segment
310 Heating element
311 Guide arm
320 Contact end
322 Contact end

What is claimed is:

1. A method for applying a heating system on a surface, the method comprising:
providing an imprint form comprising a basic form and an arm;
tampon printing a plurality of heating elements on the surface with the imprint form such that each heating element has the basic form of the imprint form and is produced with a guide arm by the arm of the respective imprint form, wherein two adjacent heating elements are connected by the guide arm, and the heating elements are made from a conductive substrate comprising conductive particles; and
connecting the heating elements to at least one heating conductor or heating segment.

2. The method according to claim 1, wherein the basic form is selected from a plurality of 2-dimensional forms, particularly dependent upon the desired design.

3. The method according to claim 1, wherein the conductive particles comprise carbon nanotubes.

4. The method according to claim 1, wherein heating elements with different basic forms of the imprint forms are produced.

5. The method according to claim 1, wherein heating segments with different relative arrangements of the heating elements are produced.

6. The method according to claim 1, wherein contact ends are configured to be provided by the guide arms or by tampon printing a further imprint form.

7. The method according to claim 1, wherein the surface is selected to be a free-form surface.

8. A device for applying a heating system on a surface in tampon printing using the method of claim 1.

9. The device according to claim 8, comprising at least one imprint form on a robot arm.

10. An external rear-view device for a vehicle comprising a heating system applied to a surface of the external rear-view device using the method of claim 1 or the device of claim 8.
